(19) United States
(12) Patent Application Publication
(10) Pub. No.: US 2009/0232575 A1
(43) Pub. Date: Sep. 17, 2009

(54) PRINTER

(75) Inventor: Norihisa Shiraishi, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/400,049

(22) Filed: Mar. 9, 2009

(30) Foreign Application Priority Data
Mar. 13, 2008 (JP) 2008-064371

(51) Int. Cl. B41J 11/00

(52) U.S. Cl. 400/619

(57) ABSTRACT

A printer having a printing mechanism unit and a body case. The printing mechanism unit transports a continuous form and to print data on the continuous form. The body case contains the printing mechanism unit. The body case has an inclined upper surface, a form-box support section, and a form-feeding port. The form-box support section supports, on the inclined upper surface, a form box containing the continuous form. The form-feeding port is located in front of an upper edge of the inclined surface and guides the continuous form to the printing mechanism unit.

### CROSS-REFERENCE TO RELATED APPLICATIONS

This application is based upon and claims the benefit of priority from the prior Japanese Patent Application No. 2008-64371, filed on Mar. 13, 2008, the entire contents of which are incorporated herein by reference.

### BACKGROUND OF THE INVENTION

1. Field of the Invention

The present invention relates to a printer in which a continuous form long is pulled from a form box held in the printer housing and data is printed in a particular manner on the continuous form.

2. Description of the Related Art

In general, continuous forms, such as fanfold paper sheets, on which printers may print data, are distributed, each in the form of a sheet contained in a cardboard form box and folded along transverse perforations made in it. Continuous forms are susceptible to temperature or humidity, and their hygroscopicity and amount of moisture may change with environmental changes. In order not to have its hygroscopicity and amount of moisture from changing, the continuous form is usually wrapped with a vinyl sheet and then packed in a form box.

To print data on a continuous form by a printer, it is fed from the form box and set on a form tray that is provided in the printer. Alternatively, the form box containing the continuous form may be first opened and then set on the form tray, because the form box, which contains the continuous form, its content is heavy.

Once the form box containing the continuous form has been set on the sheet tray, when a space may be available below the printer, it is positioned below the printer and the continuous form may be fed to the printer from below. In a printer 40 of ordinary type shown in FIG. 3, which prints data on a continuous form 41, the form 41 is fed from the form box 43 set in the sheet hopper 42. The continuous form 41 has sprocket holes (not shown) in either edge of continuous form, spaced at intervals of ½ inch. The continuous form 41 is so positioned that the pins 45a arranged at regular intervals at a tractor unit 44 extend into the sprocket holes of the sheet 41. The continuous form 41 is fed forward until its forward end reaches a stacker 48 as a motor (not shown) drives a wheel having the pins 45a in the direction of arrow b and drives also a wheel having pins 45b of a tractor unit 46 in the direction of arrow c. Data can be printed on the continuous form 41 thus fed to the stacker 48 by rotating puller rollers 47a and 47b as a fixing section. (Refer to, e.g., Jpn. Pat. Appln. Publication No. 2005-247534.)

No space may be available below the printer, for accommodating the continuous form. In this case, the continuous form must be set at the back of the printer, in the plane where the printer is installed. For example, as shown in FIG. 4 schematically, a continuous form 51 on which a printer 50 should print data is placed in a form box 51A provided at the back of the printer 50. The continuous form 51 is introduced into the printer 50 through the recording-medium feeding port 53 made in the rear of the upper cover 52 of the printer 50. In the printer 50, the form 51 is fed forwards through the nip between the platen roller 54 and the thermal head 55. (Refer to, e.g., Jpn. Pat. Appln. Laid-Open Publication No. 2008-001069.)

Assume that the form box 43 containing the continuous form is set below the printer as schematically shown in FIG. 3. Then, as the data printing proceeds, the continuous form 41 is gradually fed from the form box 43. As a result, the total weight of the form 41 and form box 43 gradually decreases. The friction between the continuous form 41 being fed upwards and the inner surface of the form box 43 pulls the box 43 upwards. Consequently, the form box 43 is moved not only upwards, but also sideways. As the form box 43 is moved sideways, it may collide with the continuous form 41 and may damage the form 41. If damaged, the form 41 may not be smoothly transported in the printer 40, or data may not be printed on the form 41 as desired. In view of this, a device that can transport the continuous form 41 smoothly must therefore be provided in the printer 40. The use of such a device would increase the manufacturing cost of the printer.

Assume that no space available below the printer, for accommodating the continuous form. In this case, the continuous form therefore is set at the back of the printer, in the plane where the printer is installed. This requires some floor area for the form box containing the continuous form. Inevitably, the printer and the form box inevitably occupy a larger floor area than otherwise.

### BRIEF SUMMARY OF THE INVENTION

It is an object of the present invention to provide a printer that needs neither a device for transporting a continuous form nor a large floor area, even if it has a form box containing the continuous form.

In an aspect of the present invention, there is provided a printer that includes a printing mechanism unit configured to transport a continuous form and to print data on the continuous form, and a body case containing the printing mechanism unit. The body case has an inclined upper surface, a form-box support section configured to support, on the inclined surface, a form box containing the continuous form, and a form-feeding port located in front of an upper edge of the incline surface and configured to guide the continuous form to the printing mechanism unit.

### BRIEF DESCRIPTION OF THE DRAWINGS

FIG. 1 is a schematic side view showing the configuration of a printer according to an embodiment of present invention;

FIG. 2 is a side view of a modification of a form-box support section incorporated in the printer according to the embodiment of the present invention;

FIG. 3 is a schematic side view showing a conventional printer.

FIG. 4 is another schematic side view showing the conventional printer.

### DETAILED DESCRIPTION OF THE INVENTION

Throughout this description, the embodiment and examples shown should be considered as exemplars, rather than limitations on the apparatus and methods of the present invention.

An embodiment of this invention will be described with reference to the accompanying drawings. The printer of the present invention is designed to print a continuous form. The following description is based on the assumption that the printer performs wire-dot matrix printing, as a printing scheme. The printer is not limited to a wire dot matrix printer, nevertheless. This invention can be applied to any other type of a printer, such as a double-side thermal printer.

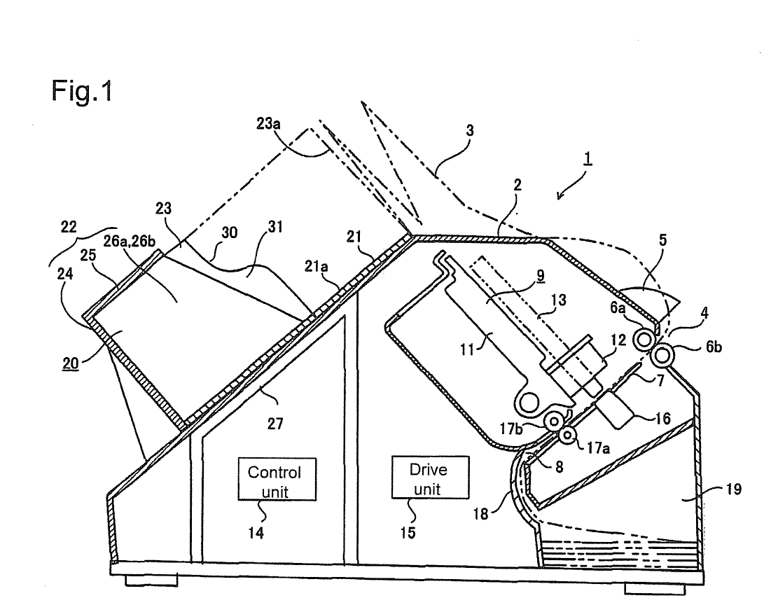

FIG. 1 is schematic side view showing the configuration of a printer according to the embodiment of present invention.

The printer 1 has a body case 2. The body case 2 holds a printing mechanism unit constituting the printer 1 that is another component of the printer 1. That side of the body case 2, at which an operator may performs some operations (hereinafter, referred to as “operation side”), has a form-feeding port 4. Through the form-feeding port 4, a continuous form 3, such as a fanfold paper sheet, can be fed into the printing mechanism unit. Near the form-feeding port 4, alignment plates 5 are provided to adjust the both lateral edges of the continuous form 3 in position, thereby to align the centerline of the form 3 with the direction of transporting the form 3. The alignment plates 5 that adjust the lateral edges of the form 3 to align the form 3 with the direction of transporting the form 3 may be replaced by a sprocket wheel that engages with the feed holes made in the continuous form 3, thereby to feed the form 3 by so-called tractor method.

Various components constituting the printing mechanism unit are arranged in the body case 2. That is, through the form-feeding port 4, a pair of entrance rollers 6a and 6b are provided. At the back of the entrance rollers 6a and 6b, a guide plate 7 configured to guide the form 3 define a form-transporting path 8, jointly with some other members. On the form-transporting path 8, a printing unit 9 is provided downstream at the entrance rollers 6a and 6b, in the direction of transporting the form 3.

The printing unit 9 has a carriage 11. The carriage 11 lies above the print side (obverse side on which to print data) of the continuous form 3 being transported through the form-transporting path 8. The carriage 11 can move back and forth in parallel to the print side of the form 3, in a direction orthogonal to the form-transporting path 8. The carriage 11 holds a wire-dot printer head 12, an ink ribbon cassette 13, and the like. The ink ribbon cassette 13 can be removed from the carriage 11. The carriage 11 reciprocates when driven with a drive force supplied from a drive unit 15. The drive force of the drive unit 15 is controlled by a control unit 14.

A platen 16 is arranged at the reverse side of the continuous form 3 being transported through the form-transporting path 8. The platen 16 is opposed to the wire-dot printer head 12 across the continuous form 3. The platen 16 is set to be longer than the distance where the wire-dot printer head 12 reciprocates in parallel to the form 3 as the carriage 11 moves.

In the printer according to this embodiment, the wire-dot printer head 12 has the structure well known in the art. Therefore, the head 12 will not be described in terms of printing operation. It should be noted, nonetheless, that in the head 12, the coil is excited, whenever needed, the armature is thereby attracted to the magnetic poles of the core, and selected wires strike the continuous form 3 on the platen 6 via the ink ribbon, thereby printing data on the continuous form 3.

A pair of transporting rollers 17a and 17b facing each other across the form-transporting path 8 are provided downstream at the printing unit 9, with respect to the direction of transporting the form 3. Further, a curved guide plate 18 having a curved cross section is arranged downstream at the transporting rollers 17a and 17b, with respect to the direction of transporting the form 3. The curved guide plate 18 is configured to change the orientation of the form 3 being transported.

A form-extracting unit 19 is provided downstream at the curved guide plate 18, with respect to the direction of transporting the form 3. If the continuous form 3 is a fanfold paper sheet, it will be held in the form-extracting unit 19, folded at the perforations. The form-extracting unit 19 lies on the operation side of the body case 2, where the operator uses the printer 1 to operate the unit 19. The operator can therefore easily handle the continuous form 3 held in the form-extracting unit 19.

A form-box support section 20 is provided on the top of the body case 2. The form-box support section 20 has an inclined surface. The inclined surface extends in the same direction as the form-transporting path 8 of the printer 1. The form-box support section 20 is composed of a sliding guide unit 21 and a form-box holder 22. The sliding guide unit 21 has a sliding surface layer 21a made of a stainless steel plate, fluororesin or the like. The form-box holder 22 is provided at the lower edge of the sliding guide unit 21 (At the lower edge of the sliding guide unit 21, the distal end of a form box 20 lies when the form box 20 slides on the sliding surface layer 21a). The surface of the sliding guide unit 21 should preferably be inclined at about 30° to about 40° to the floor. This is because the continuous form 3 will not be folded at an excessively large angle, thereby preventing jamming of the form 3.

The sliding surface layer 21a of the sliding guide unit 21 enables the form box 20, which is relatively heavy, to slide easily down. The sliding guide unit 21 may be a plate having flat surfaces. Alternatively, the sliding guide unit 21 may comprise a plurality of rails arranged in parallel to one another. Either case will do.

The form-box holder 22 has an engagement part 24 made approximately orthogonal to the direction in which the sliding surface layer 21a the sliding guide section 21 guides the form box 23. The engagement part 24 is rigid and strong enough to receive the lower edge of the form box 23 sliding down, while being guided by the sliding guide unit 21 (Note that the “lower edge” of the form 3 corresponds to the distal end of the form box 20 sliding on the sliding surface layer 21a, and faces away the above-mentioned form-feeding port 4).

Thus, the form-box holder 22 is composed of an engagement part 24, an upper wall 25, and two sidewalls 26a and 26b. The engagement part 24 receives the lower side of the form box 23 sliding down, guided by the sliding guide unit 21, and holds the from box 23. The upper wall 25 is coupled to the engagement part 24 and positioned to contact the upper side of the form box 23. The sidewalls 26a and 26b can contact the sides of the form box 23.

That side of the form-box holder 22, which is defined by the upper wall 25 and the side walls 26a and 26b and at which the form box 23 may be first inserted into the form-box holder 22, is broader than the form box 23 so that the form box 23 may be smoothly enter the form-box holder 22. That part of the holder 22, which includes the engagement part 24, has a cross section gradually narrowing toward the engagement part 24, so that the form box 23 may smoothly move toward the form-box support section 20 and may finally contact the form-box support section 20. Thus, the form box 23 can be set at its prescribed center position (also, the center position of the continuous form 3) when the form box 23 contacts the engagement part 24 of the form-box holder 22.

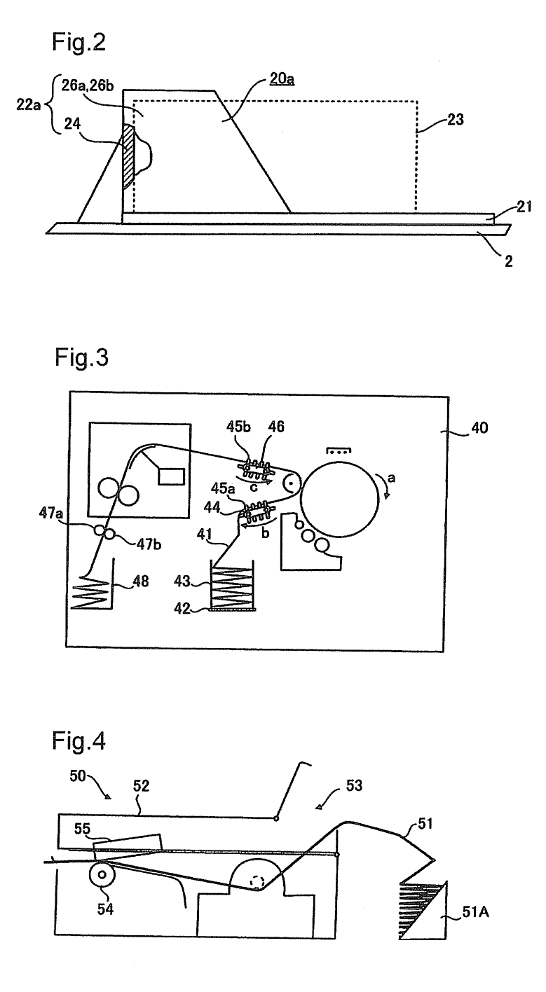

FIG. 2 shows a modification of the form-box support section 20. As shown in FIG. 2, a form-box holder 22a need not have an upper wall 25. The holder 22a may be composed of only engagement part 24 and sidewalls 26a and 26b. The form-box holder 22a can yet support the form box 23.

Hence, the form-box support section 20 and the form-feeding port 4 are positioned in the body case 2 such that the port 4 for guiding the continuous form 3 to the printing mechanism unit is arranged in front of the upper edge of the inclined surface of the form-box support section 20.

As FIG. 1 shows, the form-extracting unit 19 from which to extract the printed continuous form 3 lies closer to the operator than the opening 23a of the form box 23. Further, a reinforcing member 27 is provided in the body case 2 and opposed to the form-box holder 22. The member 27 reinforces the form-box holder 22, preventing the body case 2 from being deformed.

In the body case 2, the form-box support section 20 must be located so that the printer 1 may keep standing upright, with the form box 23 held in the form-box support section 20, in connection with the weight balance between the other components provided in the body case 2 and with the gravity centers of these components. This is because the printer 1 should not, of course, lose the balance while operating.

How to secure the form box 23 to the printer 1 configured as described above will be explained with reference to FIG. 1.

First, the operator opens the form box 23 containing a continuous form 3 such as a fanfold paper sheet. The form box 23 is a rectangular cardboard box that contains a continuous form 3. The box 23 has a cutting line 30, along which the upper part of the box 23 can be separated from the lower part thereof.

The operator may cut the box 23 along the cutting line 30, dividing the box 23 into a form-containing part 31 and a cover part. The form-containing part 31 includes the bottom and back of the box 23, while the cover part (not shown) includes the top and front of the box 23.

The cutting line 30 of the cardboard form box 23 may be perforation made in the box 23 or a tape adhered to the inner surface of the box 23, partly on the form-containing part 31 and partly on the cover part, thus coupling the form-containing part 31 and the cover part together. In other words, the form box 23 is subjected to so-called “easy-to-open process” so that the box 23 may be easily torn open along the perforation or to so-called “tape sealing process” so that the box 23 is separated into two parts by pulling the adhesive tape from outside the box 23.

After opening the form box 23, the operator may set the form box 23 on the sliding guide unit 21 of the form-box support section 20, with the form-containing part 31 contacting the sidewalls 26a and 26b of the form-box holder 22. In this case, the perforations along which the form is folded, made in the continuous form 3 contained in the form box 23 extend orthogonal to the direction in which the sliding guide unit 21 guides the form box 23 (i.e., the direction of transporting the continuous form 3).

The form box 23 is made to slide down by virtue of its own weight, guided by the sliding guide unit 21 that defines the inclined surface of the form-box support section 20. The form box 23 stops sliding when its distal end, i.e., distal end of the form-containing part 31, abuts on the bottom of the form-box holder 22, and is thereby held in the form-box holder 22.

After the form box 23 has been so set in the form-box support section 20, the operator may guide the continuous form 3 in the form box 23 until the distal end of the form 3 on the open side of the inner surface of the form box 23 comes to the form-feeding port 4 of the printer 1. The form 3 eventually abuts, at both lateral edges, on the alignment plates 5. The plates 5 therefore adjust the lateral edges of the form 3, aligning the form 3 with the centerline of the form 3 with the centerline of the form-transporting path 8.

At this point, the form box 23 has its sides contacting the sidewalls 26a and 26b, respectively. Hence, the centerline of the form 3 contained in the form box 23 and being transported is roughly aligned with the form-transporting line in the printer 1. Thereafter, the alignment plates 5 provided at the form-feeding port 4 precisely align the continuous form 3.

Now that the continuous form 3 has been aligned with the centerline of the form-transporting path 8, its distal end is guided through the form-feeding port 4 into the nip between the paired entrance rollers 6a and 6b. An entrance sensor (not shown) detects the entrance of the-continuous form 3. Then, the entrance rollers 6a and 6b rotate a prescribed number of times, transporting the continuous form 3 through the form-transporting path 8 for a predetermined distance. As the entrance rollers 6a and 6b transport the form 3 until that part of the form 3, on which to print data, comes to face the wire-dot printer head 12.

To print data on the continuous form 3, the operator may input a printing instruction at the operation side of the printer 1. When the operator inputs this instruction, the wire-dot printer head 12 prints data on said part of the continuous form 3.

The printer 1 may print data on the other parts of the form 3 existing in the form box 23 held by the form-box support section 20, one after another. When the printer 1 prints data on the last part of the continuous form 3, the form 3 no longer exists in the form box 23 held by the form-box support section 20. After the form box 23 becomes empty, it may be removed from the form-box support section 20. A new form box 23 containing a continuous form may then be set in the form-box support section 20. Thus, the continuous form 3 can be replenished easily.

In the embodiment described above, the form box 23 containing a continuous form 3 can be easily set in the printer 1 and can be easily replaced by a new form box 23 after the form box 23 becomes empty.

The printer 1 requires no space for holding the continuous form 3, outside the printer 1. The printer 1 can therefore be installed in a limited floor area.

The embodiment has been described on the assumption that it performs wire-dot matrix printing as a printing scheme. The printing scheme need not be limited to the wire-dot matrix printing. The printing scheme can be, of course, any other one, such as electrophotographic printing, thermal printing or electrostatic printing.

A form box containing a continuous form can be set in the printer according to this embodiment. The printer therefore need not have a dedicated cassette for holding the continuous form. This simplifies the configuration of the printer. In addition, the jamming of the form can be suppressed because the form-transporting path extending from the form box is simple in shape. Moreover, the floor area occupied by the printer and the form occupy is small.

It should be noted that the present invention is not limited to only the embodiment described above. The components of the embodiment can be modified in various manners in reducing the invention to practice, without departing from the spirit or scope of the invention. Further, the components of the embodiment described above may be combined, if necessary, in appropriate ways, thereby to make different inventions. For example, some of the component of the embodiment may not be used. Moreover, the components of possible different embodiments of the invention may be combined in any desired fashion.

What is claimed is:

1. A printer comprising:
a printing mechanism unit configured to transport a continuous form and to print data on the continuous form; and
a body case containing the printing mechanism unit,
wherein the body case has an inclined upper surface, a form-box support section configured to support, on the inclined upper surface, a form box containing the continuous form, and a form-feeding port located in front of an upper edge of the inclined surface and configured to guide the continuous form to the printing mechanism unit.

2. The printer according to claim 1, wherein
the form-box support section has a sliding guide unit provided on the inclined upper surface of the body case, and a form-box holder provided on the inclined surface of the body case.

3. The printer according to claim 1, wherein
the form-box support section supports the form box such that the continuous form contained in the form box is oriented with perforations, along which the form is folded, extend orthogonal to the sliding guide unit.

4. The printer according to claim 2, wherein
the form-box support section supports the form box such that the continuous form contained in the form box is oriented with perforations, along which the form is folded, extend orthogonal to the sliding guide unit.

5. The printer according to claim 1, wherein
the sliding guide unit is composed of a plurality of rail-shaped members arranged parallel to one another.

6. The printer according to claim 2, wherein
the sliding guide unit is composed of a plurality of rail-shaped members arranged parallel to one another.

7. The printer according to claim 3, wherein
the sliding guide unit is composed of a plurality of rail-shaped members arranged parallel to one another.

8. The printer according to claim 1, wherein
the sliding guide unit is composed of a sliding surface layer made of stainless steel or fluororesin.

9. The printer according to claim 2, wherein
the sliding guide unit is composed of a sliding surface layer made of stainless steel or fluororesin.

10. The printer according to claim 3, wherein
the sliding guide unit is composed of a sliding surface layer made of stainless steel or fluororesin.

11. The printer according to claim 4, wherein
the sliding guide unit is composed of a sliding surface layer made of stainless steel or fluororesin.

12. The printer according to claim 1, wherein
the inclined surface is inclined at 30° to 40° to a horizontal plane.

13. The printer according to claim 2, wherein
the inclined surface is inclined at 30° to 40° to a horizontal plane.

14. The printer according to claim 3, wherein
the inclined surface is inclined at 30° to 40° to a horizontal plane.

15. The printer according to claim 4, wherein
the inclined surface is inclined at 30° to 40° to a horizontal plane.

16. The printer according to claim 1, wherein
that side of the form box, at which the continuous form is transported, is substantially vertical to the inclined upper surface.

17. The printer according to claim 1, wherein
a form-extracting unit, at which the printed continuous form is extracted, is provided at a position closer to an operator than that side of the form box, at which the continuous form is transported.

18. The printer according to claim 1, wherein
the body case is reinforced with a reinforcing member that prevents the body case from being deformed.

19. The printer according to claim 1, wherein
alignment plates are provided at the form-feeding port 4 to adjust lateral edges of the continuous form, thereby to align a center line of the continuous form with a direction of transporting the continuous form.

20. The printer according to claim 1, which is a double-side thermal printer.
